(19) United States
(12) Patent Application Publication
(10) Pub. No.: US 2021/0248559 A1
(43) Pub. Date: Aug. 12, 2021

(54) Hierarchical Recursive Workflow Messaging Platform

(71) Applicants: Michael Palandro, Spring Hill, FL (US); Christian Wiggerman, Spring Hill, FL (US); Solomon Baba, Manchester (GB)

(72) Inventors: Michael Palandro, Spring Hill, FL (US); Christian Wiggerman, Spring Hill, FL (US); Solomon Baba, Manchester (GB)

(21) Appl. No.: 16/788,286

(22) Filed: Feb. 11, 2020

(51) Int. Cl. G06Q 10/10; G06F 16/22; G06Q 10/06; H04L 12/58; H04L 12/18

(52) U.S. Cl. CPC G06Q 10/103; G06F 16/2246; G06Q 10/105; H04L 51/34; H04L 51/04; H04L 12/1813; G06Q 10/0633

(57) ABSTRACT

A hierarchical recursive workflow messaging platform is a downloadable application presented through a browser or application user interface and stored for use on a personal electronic device. The hierarchical recursive workflow messaging platform may have a mobile application; and, can have an integrated architecture in which the internal components of the personal electronic device may be able to access a secondary application, local or remotely located on a server containing stored data for implementation. A common user interface screen may access all the functionalities and activities offered by the platform through either the computer, mobile application or the secondary application. The organizational dynamic provides contextual communications within the project/workflow management team's hierarchical structure. This permission-based communication characterizes the propriety of all messaging occurring within the team's hierarchical project workflow section. Sub-channels of communications can be created ad infinitum to facilitate respective intra company business activity as required; extending permission-based messaging on a proprietary contextual basis to associated team members.

### TECHNICAL FIELD

The present disclosure is related generally to work-flow management and, more particularly, to systems and methods for providing a hierarchical recursive workflow messaging platform.

### BACKGROUND

The hierarchical recursive workflow messaging platform discussed herein functions as part of, and may be accessed through the “core technology” platform disclosed in U.S. patent application Ser. No. 16/509,187, filed Jul. 11, 2019, entitled “Hierarchical Recursive Workflow Management Platform”, which is herein incorporated by reference for all that it teaches without exclusion of any portion thereof.

Before proceeding to the remainder of this disclosure, it should be appreciated that the disclosure may address some or all of the shortcomings listed or implicit in this Background section. However, any such benefit is not a limitation on the scope of the disclosed principles, or of the attached claims, except to the extent expressly noted in the claims.

Additionally, the discussion of technology in this Background section is reflective of the inventors' own observations, considerations, and thoughts, and is in no way intended to be, to accurately catalog, or to comprehensively summarize any prior art reference or practice. As such, the inventors expressly disclaim this section as admitted or assumed prior art. Moreover, the identification or implication herein of one or more desirable courses of action reflects the inventors' own observations and ideas and should not be assumed to indicate an art-recognized desirability.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is a schematic view of the internal components of a personal electronic device constructed in accordance with an embodiment of the present disclosure; and

FIG. 2 illustrates the hierarchical workflow depicting the vertical hierarchy of boards, lists and cards providing the trees of activities pertinent to the project/work-flow, which provide the pathways of permission-based messaging communications between team members assigned to the specific section of the project.

FIG. 3 depicts the action of creating a sub-channel from existing parent group/channel/sub-channel. It further identifies location of the messaging window; position of team members with project/workflow messaging permissions; project/workflow parent messaging window and hierarchical tree structure(s) showing recursed messaging windows, and; also showing example of intra-tree and intra-project propriety for contextual messaging levels for channels of communications.

It should be understood; that the drawings are not necessarily to scale and that the disclosed embodiments are illustrated diagrammatically and in partial views. It should be further understood; that this disclosure is not to be limited to the distinct embodiments illustrated herein.

### DETAILED DESCRIPTION

Before presenting a detailed discussion of embodiments of the disclosed principles, an overview of certain embodiments is given to aid the reader in understanding the later discussion. As noted above the hierarchical recursive workflow messaging platform discussed herein functions as part of and may be accessed through the “core technology” platform disclosed in U.S. patent application Ser. No. 16/509,187.

The platform of the referenced application is based upon methodologies and frameworks associated with managing projects, messaging and workflows. These methodologies and frameworks include the use of messaging functionality that also allows pervasive messaging to take place intra-company, through the creation of associated sub-channels of communications; as well as, to sources outside of the company, when appropriate permissions are provided as a result of the outside source's direct involvement in a specific project or workflow.

The presented platform is team-based, in that it provides management of all communications between project team members organized within the specific hierarchical structure of the team's project workflow through creation of sub-channels of communications. This establishes a hierarchical propriety for project team members associated with the specific project workflow on a permission-based hierarchical structure, predicated on permissions assigned through the directives emanating from the authority vested by project ownership/management created at the ‘parent board’ project connectivity.

The workflow's hierarchical structure allows for contextual messaging communications to be conducted within the intra-tree and intra-project structures specific to the workflow or project expressly by the team members associated with the workflow or project included within the associated intra-tree and/or intra-project section of the overall workflow. The interference from communications outside the specific project team's workflow structure are precluded to maintain integrity of organization; as it pertains, to the related boards and tasks associated with the specific project section and structured relationship within the team members proprietary based project messaging.

The messaging platform allows for the automatic assignation of permissions for members of the project workflow team providing open messaging communications between team members by the proprietary organized process presented through the hierarchical structure of the workflow. As the structure of the project workflow expand and new members are added to the respective project, when boards and/or tasks are recursed; messaging communication permissions also expand to include newly assigned team members. The permission-based integrity presented by the platform and applied to permit communication(s) to be appropriately conducted, which are presented by the hierarchical structure of the chain of command, represented by the nature of the team members' positioning within the tree structure of the project workflow.

The platform precludes message communications from outside the structure of the project workflow from being conducted to and from members of project teams not included in the permission-based structure; which are represented by the composition of the specific team assigned to the specific boards and tasks, associated with the section of the project workflow to be completed. The impetus of the permission-based hierarchical platform structure is to maintain the organized integrity for contextual communications, for and between the nested team members, represented by the specific boards and tasks, positioned in the hierarchical structure of the intra-tree and/or intra-project tree positioning within the project workflow.

The platform is based upon methodologies and frameworks associated with managing projects, messaging and workflows. These methodologies and frameworks include the use of messaging functionality that also allows pervasive messaging to take place intra-company; as well as, to sources outside of the company, when appropriate permissions are provided as a result of the outside source's direct involvement in a specific project or workflow. The presented platform is team-based, in that, it provides management of all communications between project team members organized within the specific hierarchical structure of the team's project workflow. The platform is predicated on hierarchical structure of permissions assigned through the directives emanating from the authority vested by project ownership/management created at the ‘parent board’ project connectivity.

With specific regard to the workflow's hierarchical structure presented by the platform; which allows for contextual messaging communications to be conducted within the intra-tree and intra-project structures specific to the workflow or project expressly by the team members associated with the workflow or project included within the associated intra-tree and/or intra-project section of the overall workflow. Interference from communications outside the specific project team's workflow structure are precluded, maintaining the integrity of organization within the project workflow for assigned project team members.

The messaging platform allows for the automatic assignment of permissions for members of the project workflow team providing open messaging communications between team members, through the hierarchical structure of the workflow. As the structure of the project workflow expand and new members are added to the respective project, when boards and/or tasks are recursed, messaging communication permissions also expand to include newly assigned team members. The permission-based integrity presented by the platform are conducted in accordance to the hierarchical structure permitted by the chain of command.

With this overview in mind and turning now to a more detailed discussion in conjunction with the attached figures, the techniques of the present disclosure are illustrated as being implemented in or via a suitable device environment. The following device description is based on embodiments and examples within which or via which the disclosed principles may be implemented and should not be taken as limiting the claims with regard to alternative embodiments that are not explicitly described herein.

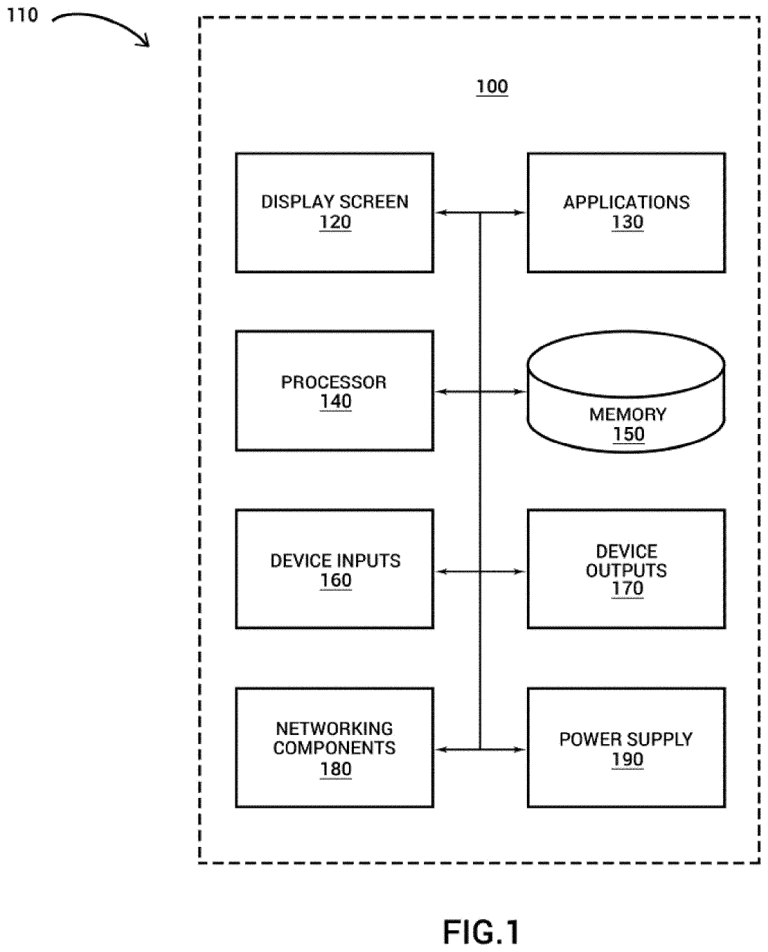

Referring now to FIG. 1, a personal electronic device 100 is depicted upon which the hierarchical recursive workflow management system 110 can be accessed. In the illustrated embodiment, the components of the personal electronic device 100 include a display screen 120, applications (e.g. programs) 130, a processor 140, a memory 150, one or more device inputs 160, and one or more device outputs 170. The personal electronic device 100 may be a mobile device, such as a smartphone, a laptop computer, a tablet computer (or pad), an electronic book (eBook reader, or other mobile or personal electronic devices that may be used to communicate wirelessly (or via a fixed link) and allow the user to view and share information. Moreover, the personal electronic device 100 may also be any computer, such as a desktop computer, or processor-based device that may use fixed (or wireless) links to communicate with other components and devices.

The display screen 120 may be connected to the processor 140 and memory 150 of the personal electronic device 100. When a user accesses the personal electronic device 100, the display screen 120 may visually represent the encoded software of the operating system of the personal electronic device 100 saved within the memory 150. Additionally, the display screen 120 may visually show the applications 130 accessed by the user which also may be stored within the memory 150 of the personal electronic device 100. The display screen 120 may have the added benefit of being operable as a device input 160. As a device input 160 the display screen 120 may respond to the touch of a user or a stylus to allow the user to input information into the personal electronic device 100 regarding the operation of programs or applications 130 stored within the personal electronic device 100. Additionally, as a device input 160, the display screen 120 may be able to scan and recognize a user's fingerprints, if a user places their finger within a certain portion of the display screen 120 for recognition and input.

The processor 140 can be any of a microprocessor, microcomputer, application-specific integrated circuit, or the like. For example, the processor 140 can be implemented by one or more microprocessors or controllers within an integrated circuit design. Similarly, the memory 150 may reside on the same integrated circuit as the processor 140. The memory 150 may include a random-access memory (i.e., Synchronous Dynamic Random-Access Memory (SDRAM), Dynamic Random-Access Memory (DRAM), RAMBUS Dynamic Random-Access Memory (RDRM) or any other type of random-access memory device or system). Additionally, or alternatively, the memory 150 may include a read only memory (i.e., a hard drive, flash memory or any other desired type of memory device).

The information that is stored by the memory 150 can include program code associated with one or more operating systems or applications 130 as well as informational data. Although the memory 150 is usually located locally within the personal electric device 100, the memory 150 may be accessed by the networking components 180 if it is located remotely on a network server or cloud-based computing component. The operating system and applications 130 are typically implemented via executable instructions stored in a non-transitory computer readable medium within the memory 150 to control basic functions of the personal electronic device 100. These functions may include interaction among various internal components of the personal electronic device 100 and storage and retrieval of applications 130 and data to and from the memory 150.

With respect to the applications 130 stored within the memory 150, these typically utilize the operating system to provide more specific functionality. In an embodiment of the present disclosure, the hierarchical recursive workflow management system 110 may be a mobile application located within the memory 150 of the personal electronic device 100. Many applications 130 stored within the memory 150 may provide standard or required functionality of the personal electronic device 100. However, in other cases applications 130 such as the hierarchical recursive workflow management system 110 of the disclosure provide optional or specialized functionality, and maybe supplied by third party vendors.

As stated above the personal electronic device 100 may have a device input 160 and a device output 170. Examples of the device input 160 and device output 170 may include a touch screen or a physical keyboard, a stylus, a microphone, a camera, a speaker, wireless interface, infrared interfaces, and/or other input/output interfaces which may be present on the personal electronic device 100. A user may input information through the device input 160 which would then be sent to the processor 140 and memory 150 to execute the inputted information. Furthermore, the device output 170 may produce the required output, either visually or audibly, dependent on the execution of the applications 130 or commands executed by the processor 140 of the personal electronic device 100.

Furthermore, the personal electronic device 100 may include software and hardware networking components 180 to allow communications to and from the personal electronic device 100. The personal electronic device 100 may have one or more wireless access technologies or interfaces, such as a chip or component, to enable the personal electronic device 100 to establish a fixed or wireless link to an outside network. Additionally, the personal electronic device 100 may have one or more wireless technology interfaces that may communication with one or more of the other components of the personal electronic device 100.

The wireless technologies and interfaces that may be used by the corresponding components of the personal electronic device 100 may include a Bluetooth interface, and Institute of Electrical or Electronic Engineers (IEEE) 802.11 compliant (or Wi-Fi) wireless interface, a near field communication (NFC) link, an Infrared Data Association interface, a Radio-Frequency identification interface or a radio frequency transponder, a reflection antenna chip, cellular interface, and or any other wireless technology interface that may be applicable to the personal electronic device. These networking components 180 provide wireless networking functionality, although wired networking may additionally or alternatively, be supported.

Moreover, a power supply 190, such as a battery or fuel cell, may be included for providing power to the personal electronic device 100 and its components. All or some of the internal components communicate with one another by way of one or more shared or dedicated internal communication links 195, such as an internal bus. Through these internal communication links 195, power and data may be shared between the multiple internal components of the personal electronic device 100.

In an operational setting, the personal electronic device 100 is programmed such that the processor 140 and memory 150 interact with the other components of the personal electronic device 100 to perform a variety of functions. The processor 140 may communicate with the memory 150 to implement various modules and execute programs for different activities such as launching an application, transferring data, and toggling through various graphical user interface objects representing thumbnail images of executable programs stored within the memory 150.

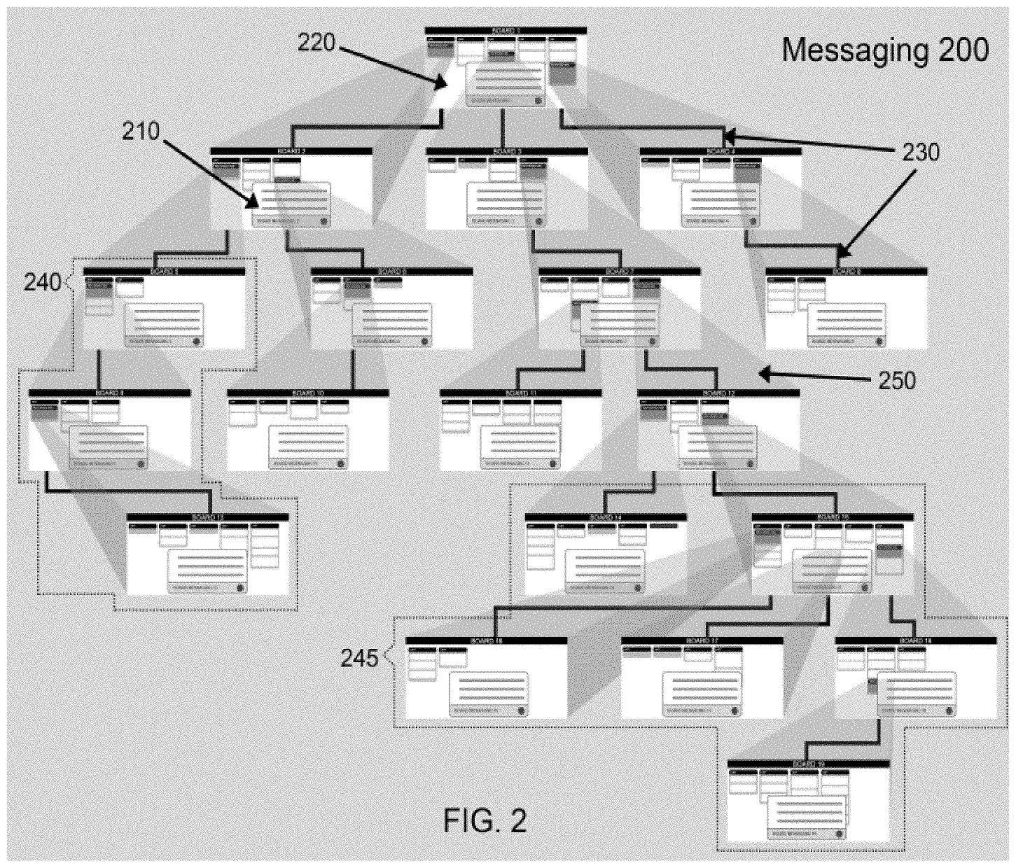

Referring now to FIG. 2, the illustrated architecture 200, vertically shows a multitude of workflow process stages recursively developed to complete an initially required workflow to be accomplished. The workflow is comprised of boards, lists and cards which in aggregate represent the complex of activities identified as the process steps and resources which characterize the project/workflow. Represented within each board is a “message box” 210, which is the notification center for all messaging received and sent by permission-based assigned team members, specific to that sector of project/workflow activity. Assigned team members have the capability to appropriately exchange project/workflow related messages through the messaging platform's message box feature.

Review and exchange of messaging within the workflow hierarchical structure start from the top of the section of workflow activity at the parent board (220), for that identifiable section of project/workflow to be conducted. Assigned team members will be given permissions based upon what board their task is affiliated; in conformity to where they are situated in the hierarchy of the project/workflow tree. The assigned members of the parent board (220) have review permission over all boards noted in the vertical structure of the hierarchy situated under the positioning of the parent board (220).

The messaging chain of command (230) is governed by the assigned permissions reflected in a team member's board positioning in the hierarchy of the project/workflow. This positioning derives from the parent board (220), being the highest positioning to the lowest board noted in the vertical hierarchy. This level of permission-based messaging communication characterizes the critical propriety provided for the team members included as part of that specific hierarchical project workflow section.

The organizational dynamic included as an integral part of the hierarchical recursive workflow messaging platform, provides contextual communications within the project/workflow management team's hierarchical structure; shown as part of the specific intra-tree (240) or intra-project (245) positioning, within the overall hierarchical project workflow. Other messaging communications which derivate from outside the propriety of the team members intra-tree (240) and/or intra-project (245) specific hierarchical workflow positioning; would be precluded from inclusion in that section of the project's hierarchical workflow structure. The impetus and integrity provided by the platform allows for team members to continuously conduct contextual permission-based messaging; within the parameters, of the specific hierarchical workflow; without any project disruptive influences created by chaotic and hap-hazard messages from sources outside of the group of assigned team member's, which are associated by either the intra-tree (240) or intra-project (245) positioning within the overall project's hierarchy.

As requirements dictate that a project/workflow needs to be expanded; and, boards are recursed (250) to facilitate expansion, existing; as well as, newly assigned team members, are automatically provided the permissions; which are required, to effectively conduct messaging within in the hierarchy of the intra-tree (240) or intra-project (245) specific project workflow.

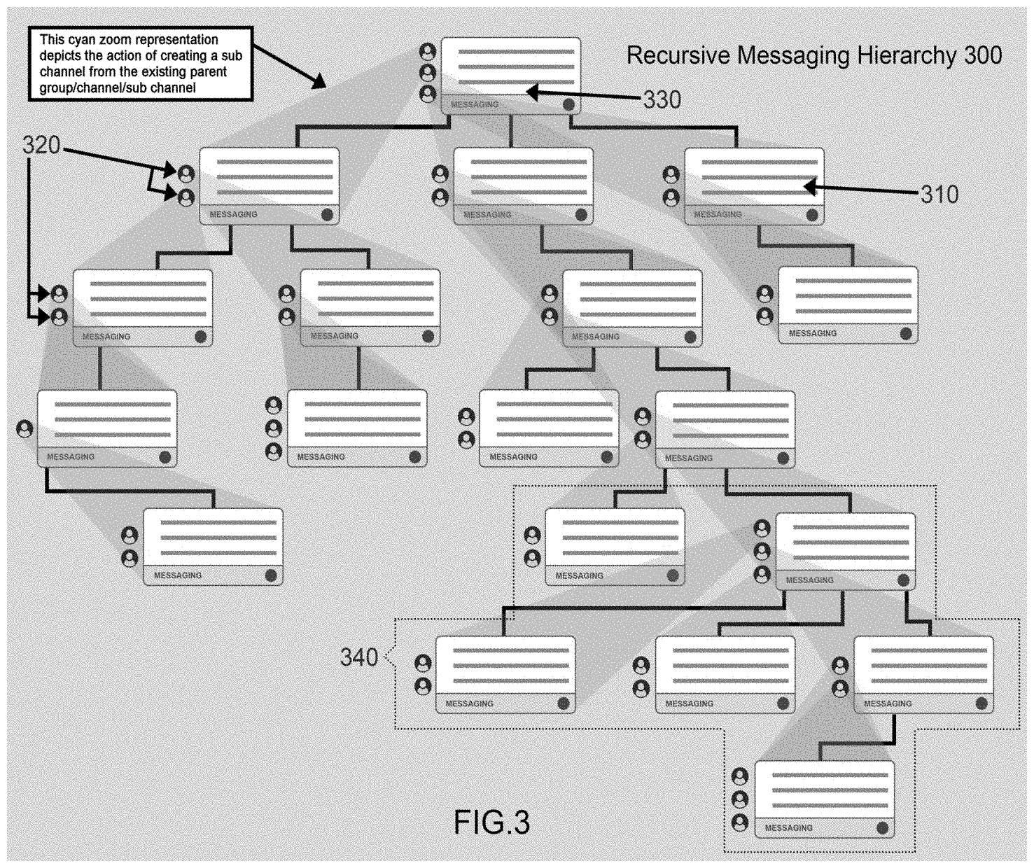

Referring now to recursive workflow messaging as depicted at FIG. 3. Recursive Messaging Hierarchy (300), is a contextual messaging platform which enables any group of entities or members (320) in any group based environment through any mechanism to conduct intra communication in a workflow pattern that gives further accessibility to create infinitely more sub channels within the same workflow (340) to facilitate greater granularity of details associated with the original conversation. The messages are displayed respectively in the messaging window (310) within boards associated with the created sub channels of communications to facilitate messaging requirements at the intra tree and intra project hierarchical structures of the workflow (330).

The group based interface is set up to display all group conversations in the same interface in the work flow (340) and all messages are sent and received by all group members from the same interface, but as further deliverables are needed within the same workflow; then, the workflow is further segmented into many more sub channels within the overall header workflow channel (340) and any member from any workflow or group can be added to the newly created sub channel in order to allow for separate discussions/conversations inside the same workflow/channel.

At the creation of a parent workflow/channel (310), team members (320) are added to the sub channel and all team members use the created communication channel to message, as required for the project/task/deliverable the team members are associated. As business requirements dictate team members can create additional sub channels of communications inside the parent workflow/channel (340) and have the capability to add any existing or new team members to establish separate discussions.

When additional deliverable/conversation is necessitated; then, another sub channel can be created within the first level sub channel; additional team members may be added as required, creating a new and separate line of messaging (340). The creation of additionally required sub channels of communications can continue to happen when business circumstances dictate that the workflow be recursed in order to create additional channels of communications, which can be conducted, as required, until all necessary details of granularity have been disclosed.

The recursive messaging hierarchy diagram (300) depicts the components applicable to create sub channels of communications as business workflow/project activities require. The propriety of the permission-based sub channels are created from a recognized Level-0 workflow/channel messaging; from which a new communication channel can be created as required as a Level-1 workflow/sub channel-1; from which a new communication channel can be created as required as a Level-2 workflow/sub channel-2; from which a new communication channel can be created as required as a Level-3 workflow/sub channel-3; from which new communication channels can be created as required created workflow/sub channels which are created nests upon each subsequent sub channel created. Therefore, all subsequently created sub channels are dependent from the parent channel/workflow allowing organizations to create as many workflow/channels as business requires.

It will be appreciated that various systems and processes have been disclosed herein. However, in view of the many possible embodiments to which the principles of the present disclosure may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof

What is claimed is:

1. A system for providing a hierarchical recursive workflow messaging platform comprising:
a nontransitory computer-readable medium having stored thereon data and programmatic code, the data including a permission-based hierarchical intra-tree and intra-project protocol; and
a processor configured to manage a messaging functionality in conjunction with the nontransitory computer-readable medium by managing, tracking and executing project/workflow team messaging, wherein the team messaging is conducted in accordance with the permission-based hierarchical intra-tree and intra-project protocol.

2. The system in accordance with claim 1, wherein the processor is further configured to implement a chain of command messaging format which permits users at a top of the hierarchical tree ability to view all messages communicated by assigned team members.

3. The system in accordance with claim 1, wherein the permission-based structure precludes communications not pertinent to the project/workflow hierarchical tree activity, thereby, maintaining organized messaging within the team structure salient to the objectivity of the team member's project/workflow activity.

4. The system in accordance with claim 1, wherein permissions assigned through parent board project/workflow connectivity ensure integrity of contextual communication throughout team messaging, by creation of sub-channels of communications as business activities have dictated, whether conducted intra-tree or intra-project.

5. The system in accordance with claim 4, wherein permissions for existing and newly assigned team members are populated automatically, and new members can be added, when sub-channels are created, as boards are recursed to further expand and/or granularize the parameters of team's project/workflow responsibilities.
